(19) United States
(12) Patent Application Publication
(10) Pub. No.: US 2018/0236780 A1
(43) Pub. Date: Aug. 23, 2018

(54) CONTAINER TREATMENT MACHINE AND METHOD FOR PRINTING ON CONTAINERS

(71) Applicant: KRONES AG, Neutraubling (DE)

(72) Inventors: August PEUTL, Neutraubling (DE); Andreas SONNAUER, Neutraubling (DE); Florian LAUTERBACH, Neutraubling (DE); Heinz HUMELE, Thalmassing (DE)

(21) Appl. No.: 15/750,793

(22) PCT Filed: Jun. 9, 2016
(86) PCT No.: PCT/EP2016/063130

§ 371 Date: Feb. 6, 2018

(30) Foreign Application Priority Data
Aug. 10, 2015 (DE) 102015215227.8

(51) Int. Cl. B41J 3/407; B41J 11/00; B41F 17/18; B41J 3/54

(52) U.S. Cl. CPC B41J 3/4073; B41J 3/543; B41F 17/18; B41J 11/0015

(57) ABSTRACT

A container treatment machine for printing on containers, comprising a transport device configured in particular as a carousel and used for transporting a container flow along a transport track, and further comprising direct printing heads stationarily arranged on the transport track and used for applying a direct print to the container, characterized in that at least two of the direct printing heads are configured for applying the same printing ink to a container.

The present invention relates to a container treatment machine for printing on containers, which has the features of the preamble of claim 1, and a method for printing on containers, which has the features of the preamble of claim 12.

In container identification processes, container treatment machines, which comprise a direct printing head and in the case of which the containers are directly printed on, are now used alternatively or additionally to the known labeling machines. Such a direct printing head works e.g. according to the inkjet printing method, where individual ink droplets are applied by means of a plurality of printing nozzles to a print area on the container. The printing nozzles are here normally arranged in one or in a plurality of parallel rows of nozzles and can be controlled individually. In order to allow areal printing on the containers, the latter are rotated by means of container accommodation units relative to the direct printing head, so that an areal print is created.

For multi-colored printing, a plurality of direct printing heads are arranged further along the transport track of a transport device in a stationary manner, said direct printing heads applying the individual printing inks successively onto the container periphery.

A container treatment machine for printing on containers with direct printing heads is known e.g. from DE 10 2012 213080 A1. Containers are here received in container accommodation units on a carousel and moved along a transport track past direct printing heads with different printing inks and are printed on in several colors. The transport of the respective container is here stopped at a printing position in front of the respective direct printing head, the container is rotated about its longitudinal axis and printed on areally. The printing ink is e.g. a UV-curable printing ink, which, when the printing process has been finished, is cured by a UV light source.

The print quality and the container throughput of the container treatment machine are here primarily limited by the performance of the direct printing heads. The latter have a certain number of printing nozzles along a certain print height, whereby the resolution of the direct print is determined. In addition, ink application is limited by the maximum firing rate of the printing nozzles.

Hence, it is the object of the present invention to provide a container treatment machine and a method for printing on containers, by means of which an improved print quality and a higher container throughput will be possible.

In the case of a container treatment machine for printing on containers, which has the features of the preamble of claim 1, this object is achieved by the characterizing clause, according to which at least two of the direct printing heads are configured for applying the same printing ink to a container.

Due to the fact that two of the direct printing heads are configured for applying the same printing ink to a container, the printing ink can be applied with a higher print dot density or to several print areas at the same time. In addition, it is thus possible to print on the same printing point with both direct printing heads and to compensate for the failure of a nozzle in this way. It follows that the two direct printing heads allow to increase the print quality and the container throughput of the container treatment machine.

The container treatment machine for printing on containers may be arranged in a beverage processing plant. The container treatment machine may be arranged downstream of a filling plant for filling a product into the containers and/or downstream of a capper. The container treatment machine may, however, also be arranged upstream of the filling process and/or directly downstream of a container production process.

The containers may be provided for accommodating therein beverages, sanitary products, pastes, chemical, biological and/or pharmaceutical products. In general, the containers may be provided for any kind of flowable and fillable media. The containers may consist of plastic, glass and metal, but hybrid containers with mixtures of materials are imaginable as well. The containers may be bottles, cans and/or tubes. The containers may be specially shaped containers having at least one surface that deviates from rotational symmetry about the longitudinal axis of the container. The specially shaped containers may comprise at least one relieflike surface area.

The transport device may especially be configured as a carousel that is rotatable about a vertical axis. “Vertical” may here mean that this is the direction which is directed towards the center of the earth. For accommodating the containers, the transport device may comprise container accommodation units which are arranged preferably on the circumference of the carousel. The transport device may be configured for stationarily positioning the containers during the printing process at predetermined printing positions opposite to a direct printing head. Likewise, it is imaginable that the transport device is configured for moving the containers during the printing process along the transport track or a printing track. In this way, especially flat print areas on specially shaped containers can be printed on through the movement along the track.

It is imaginable that the container treatment machine comprises a distributor carousel having arranged thereon a plurality of the transport devices as satellite carousels, each satellite carousel having assigned thereto a plurality of direct printing heads. Each satellite carousel may comprise at least two of the direct printing heads for applying the same printing ink to a container. A respective satellite carousel may have assigned thereto direct printing heads for applying different printing inks or only one printing ink. The arrangements of the distributor carousel with a plurality of satellite carousels allow the machine throughput to be increased still further.

For applying an areal print to the container, the container accommodation units may be configured to displace the containers relative to the direct printing head during the printing process and/or to rotate them. In particular, the container accommodation units may be configured for displacing and/or rotating the container surface perpendicularly and/or parallel to a printing direction of the direct printing head. “Printing direction of the direct printing head” may here mean that this is the direction in which the printing droplets are ejected from the direct printing head. The container accommodation units may comprise a centering bell, a rotary plate, a displacement unit and/or a direct drive.

“Container flow” may here mean that these are the containers transported by the transport device when the machine is in operation. The transport track may be the traveling track along which the containers are transported by the transport device when the machine is in operation.

The direct printing heads may operate according to a digital or inkjet printing method, in the case of which the ink is transmitted to the container by means of a plurality of printing nozzles. “Inkjet printing method” may mean that in chambers of a printing nozzle a sudden increase in pressure is generated via piezo elements or thermocouples in such a way that a small amount of printing fluid is pressed through the printing nozzles and transmitted to the container as a printing droplet. Each printing nozzle may be configured for producing a print dot on the container. The direct printing head may comprise a number of printing nozzles in a range of 100-10000, in particular in a range of 500-1024 nozzles. The printing nozzles may be arranged in one or in a plurality of parallel nozzle rows (e.g. 1-8), which are arranged in particular parallel to the axis of the container. A direct printing head may also be composed of individual printing chips, e.g. printing chips of the “FUJIFILM SAMBA” type.

That “the direct printing heads are arranged stationarily on the transport track” may here mean that the direct printing heads are fixedly arranged on a machine base. In particular, it may mean that the direct printing heads and the container accommodation units are not jointly secured in position on the transport device.

That “two of the direct printing heads are configured for applying the same printing ink to a container” may here mean that, when the machine is in operation, the direct printing heads jointly apply a printing ink, e.g. a printing ink of the color cyan, to the container. The direct printing heads may, for example, be connected to the same ink feeding unit. The ink feeding unit may be provided for feeding a printing ink to the direct printing heads from an ink supply. The ink feeding unit may comprise a hose, a pump and/or a reservoir. The printing ink may be an ink having a specific color, such as cyan, magenta, yellow, blue, red, green, white or black. Also special colors, such as the color system Pantone or RAL, are imaginable.

The two direct printing heads may each comprise in a nozzle group at least one row with regularly spaced printing nozzles, and the two direct printing heads may be arranged with an offset in the direction of the nozzle rows on the transport track. In this way, either the print height or the print resolution can be increased. The nozzle rows of a nozzle group may be arranged in parallel and may preferably be offset relative to one another in the direction of the nozzle rows, the offset corresponding to the distance between two neighboring printing nozzles of a nozzle row divided by the number of nozzle rows of a nozzle group. In this way, the resolution of a nozzle group can be increased. The printing nozzles of a nozzle group may be spaced apart such that the direct print will have a resolution of 100-600 dpi (dots per inch) in the direction of the nozzle row.

In order to increase a print resolution, the offset may correspond to the distance between two neighboring printing points of a nozzle group multiplied by the factor 0.5+k, k being a positive or a negative integer or zero. In particular, the offset may correspond to half the distance between two neighboring printing points of a nozzle group. In other words, the print images of the two direct printing heads may be interlaced such that the image lines of the direct print are alternately associated with one of the two direct printing heads.

For increasing a print height, the offset in the direction of the nozzle rows may correspond to at least a length of the nozzle row. In other words, the two direct printing heads may be arranged at different heights relative to the transport track. Preferably, the two direct printing heads are additionally arranged with an offset in the direction of the transport track, so that the print images of the two direct printing heads directly adjoin one another one on top of the other. By way of example, the offset for increasing the print height may correspond to the distance between two neighboring nozzles of a nozzle row plus the length of the nozzle row. The offset in the direction of the nozzle rows may be perpendicular to the transport track, parallel to the longitudinal axes of the containers and/or in the vertical direction.

The two direct printing heads may be arranged on the transport track in opposed relationship with one another, so that two print areas of a container can be printed on simultaneously. The arrangement of the direct printing heads is thus particularly compact and the container can be printed on from two sides simultaneously and thus in a time-saving manner. It is imaginable that containers which are rotationally symmetric about their longitudinal axes are positioned between the two direct printing heads by means of the transport device and that the container is rotated by 180° during the printing process. Likewise, it is imaginable that specially shaped containers are moved along the transport track by means of the transport device and are simultaneously printed on from two sides by the direct printing heads.

The two direct printing heads may be arranged on different sides of the transport track and/or in the direction of the transport track in succession. For example, the first direct printing head may be arranged on one side of the transport track and the second direct printing head may be arranged in displaced relationship therewith along the transport track on the other side of the latter. Hence, the movement of the container transversely to the transport track will then only be limited towards one side by one of the direct printing heads and, consequently, a more flexible movement will be possible, in particular in the case of specially shaped containers.

In order to increase a container throughput and/or a print quality, four of the direct printing heads may be configured for applying the same printing ink to a container. The four direct printing heads may comprise the two direct printing heads described hereinbefore with respect to claims 1-6. In this way, four different print areas can be printed on simultaneously, whereby the container throughput can be increased still further.

The container accommodation units may be configured such that they are rotatable by means of direct drives and a machine control unit may be configured for controlling the direct drives as well as the printing heads. This allows a synchronization of the control between the direct printing heads and the container accommodation units. The direct drives may comprise a servomotor, a torque motor and/or a gear unit. The direct drives may be configured to rotate the container accommodation units and/or to move them along a curve or a straight line.

The machine control may be configured to rotate the container accommodation units by up to 180° while the two print areas are printed on simultaneously. In this way, the respective halves of the container circumference can printed on simultaneously by means of the two direct printing heads.

The machine control can be configured for rotating the container accommodation units such that a print area of the container is adapted to be printed on by both direct printing heads, wherein in particular all the printing points of the print area are adapted to be printed on by both direct printing heads for redundancy. Hence, clogging of the nozzle of a direct printing head will have a less strong effect on the print image. For example, one direct printing head may eject three printing droplets onto a printing point during the printing process, and then the second direct printing head may eject further three printing droplets onto this printing point. It follows that a total of six printing droplets will be ejected onto the printing point. It is also imaginable that, during the cleaning process, one of the direct printing heads will continue to print while the other one is being cleaned.

The machine control may be configured for rotating the container accommodation units such that, when a non-rotationally-symmetric surface area of the container is being printed on, a printing distance to the direct printing head carrying out the printing operation will remain substantially constant. In this way, the container accommodation units with the containers can be moved such that a surface deviating from rotational symmetry will nevertheless be moved past the direct printing head carrying out the printing operation at a constant printing distance from the latter. This results in a higher quality of the print image. The direct printing head carrying out the printing operation may be one of the two direct printing heads configured for applying the same printing ink to a container. The direct printing heads may here preferably be arranged on different sides of the transport track and in succession when seen in the direction of the transport track. In this way, a particularly large scope for a compensating movement of the container will be obtained.

In addition, the present invention provides in claim 12 a method for printing on containers, wherein a container flow is transported along a transport track by means of a transport device, which is configured especially as a carousel, and the containers have applied thereto a direct print by means of direct printing heads arranged stationarily on the transport track, characterized in that the same printing ink is applied to a container at least by means of at least two of the direct printing heads.

Due to the fact that the same printing ink is applied to a container by means of the two direct printing heads, printing ink can be applied to different areas of the container simultaneously in order to increase the container throughput. Likewise, the resolution can be increased through an interlaced application of the print dots by the two direct printing heads, and a sufficient print quality can be guaranteed by redundant printing in spite of a failure of individual nozzles.

According to this method, the two direct printing heads may be arranged in opposed relationship with one another on the transport track and two print areas of the container may be printed on simultaneously, especially with the container being rotated by up to 180°. Hence, it is no longer necessary to rotate the container by full 360° during printing, but 180° will suffice. Preferably, the container may be rotated by precisely 180° during printing.

The same print area on the container may be printed on by both direct printing heads in an interlaced manner or with a respective part of the printing ink quantity per printing point. Due to the interlaced printing by means of both direct printing heads, the print lines are printed on alternately by one of two direct printing heads, thus increasing the resolution. When a printing point is printed on by means of both direct printing heads, it will, however, be possible to conceal the failure of the nozzle of a direct printing head by redundant printing with the corresponding nozzle of the other direct printing head.

When a non-rotationally-symmetric surface area of the container is printed on, the container can be rotated such that a printing distance to the direct printing head carrying out the printing operation will remain substantially constant. For example, a specially shaped container having an oval cross-section may be rotated during transport along the transport track such that the point to be printed on will move towards or away from the direct printing head. A compensation of the non-rotationally-symmetric surface contour will thus be possible. The printing distance may be the distance between a printing nozzle and the respective point at which the printing ink impinges on the container.

The method for printing on containers described with respect to claims 12-15 may be executable by means of a container treatment machine according to one of the claims 1-11 and/or may comprise the features, which have been described hereinbefore with respect to the container treatment machine, individually or in arbitrary combinations.

Further features and advantages of the present invention will be described in more detail hereinafter making reference to the embodiments shown in the figures, in which:

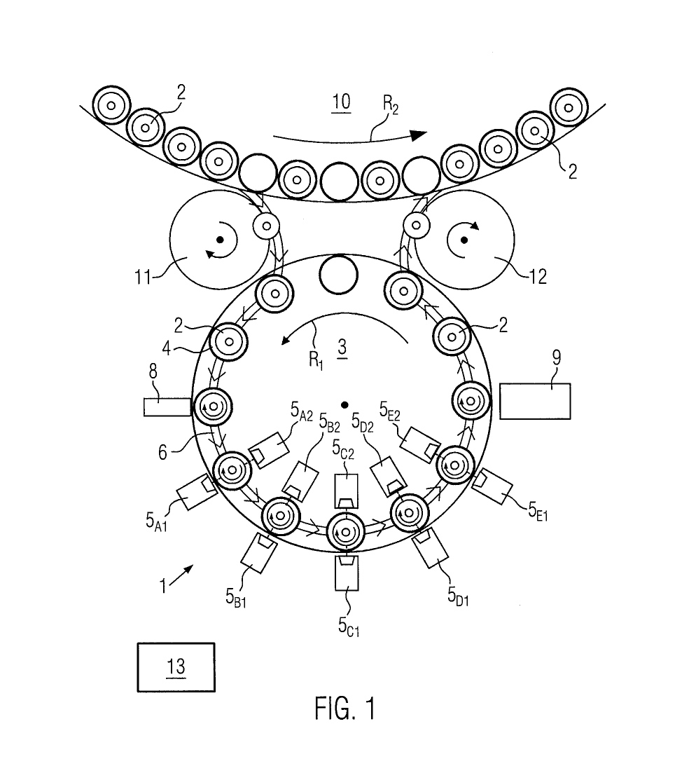

FIG. 1 shows, as a survey, an embodiment of a container treatment machine for printing on containers in a top view;

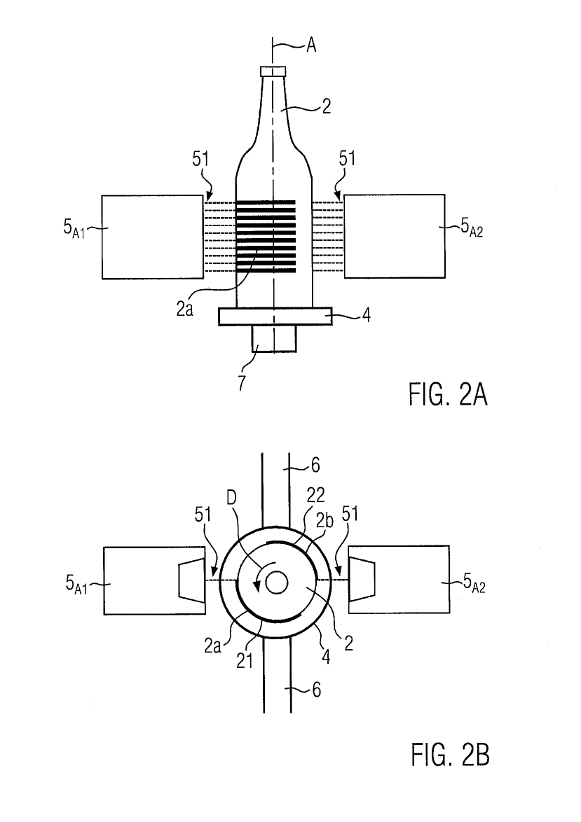

FIG. 2A-2B show a detail view of the embodiment according to FIG. 1 with two direct printing heads, which are configured for applying the same printing ink to a container;

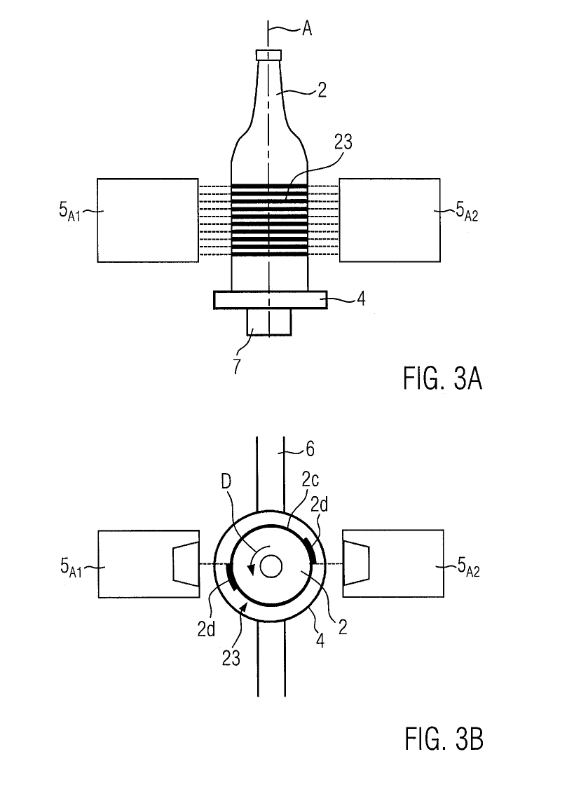

FIG. 3A-3B show a detail view of a further embodiment, in which a printing point on the container is printed on by two direct printing heads with the same printing ink for redundancy;

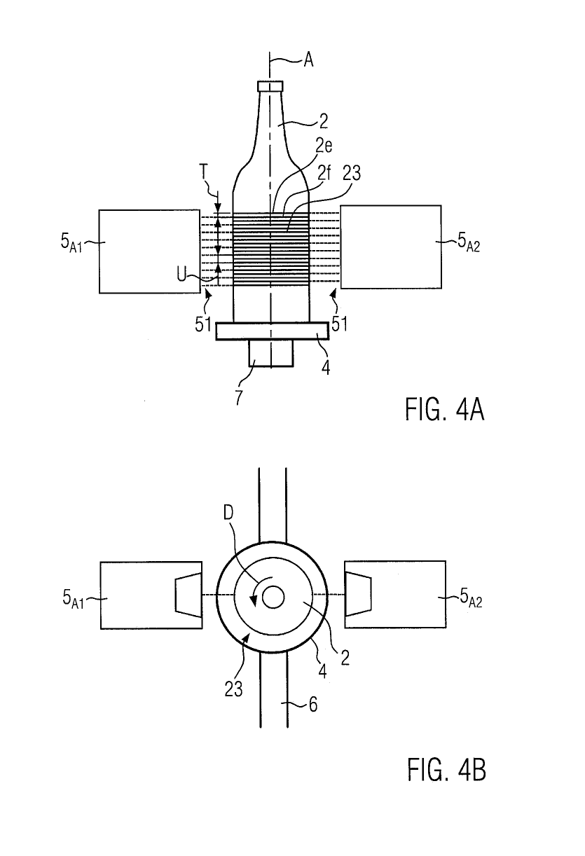

FIG. 4A-4B show a detail view of a further embodiment, in which the resolution is increased by arranging two direct printing heads with an offset;

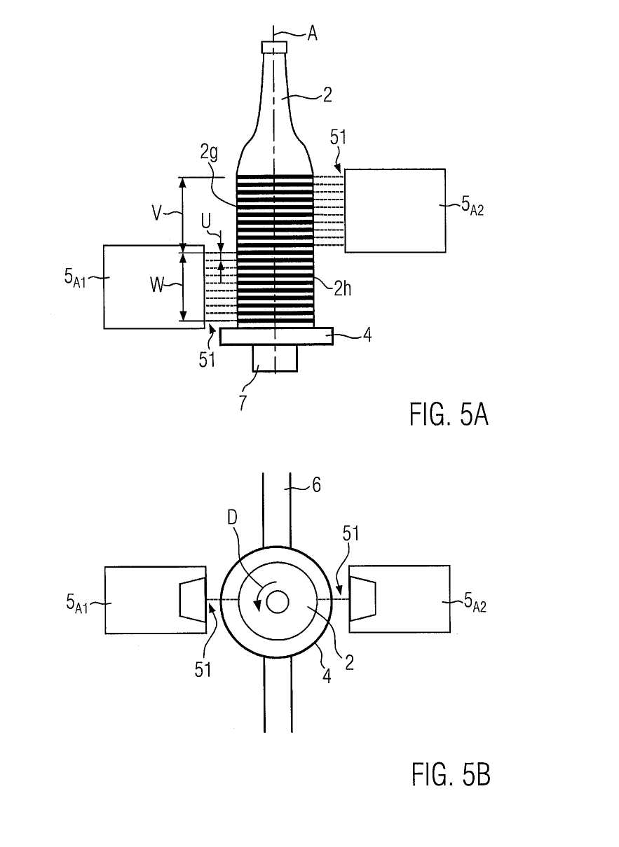

FIG. 5A-5B show a detail view of a further embodiment, in which the print height is increased by arranging two direct printing heads with an offset;

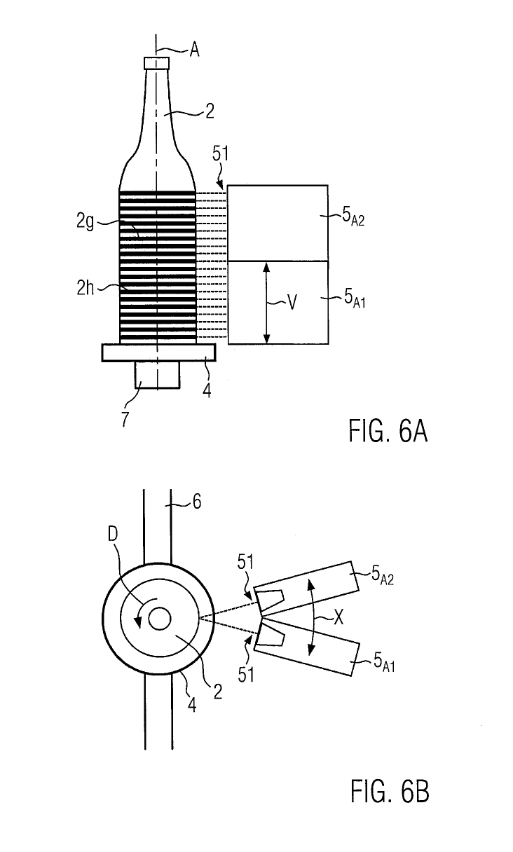

FIG. 6A-6B show a detail view of a further embodiment, in which the printing heads are arranged alternatively in comparison with FIG. 5A-5B;

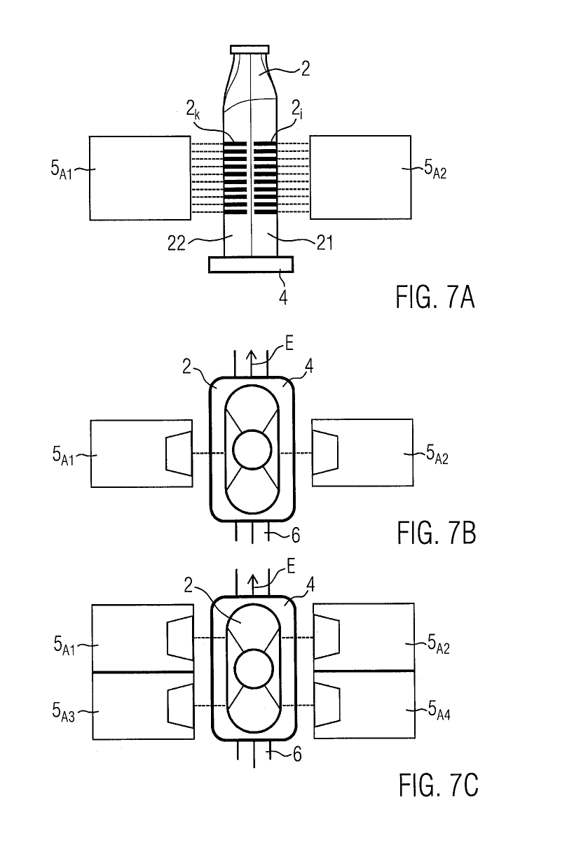

FIG. 7A-7C show a detail view of a further embodiment, in which a specially shaped container is printed on from both sides with the same ink by two direct printing heads; and

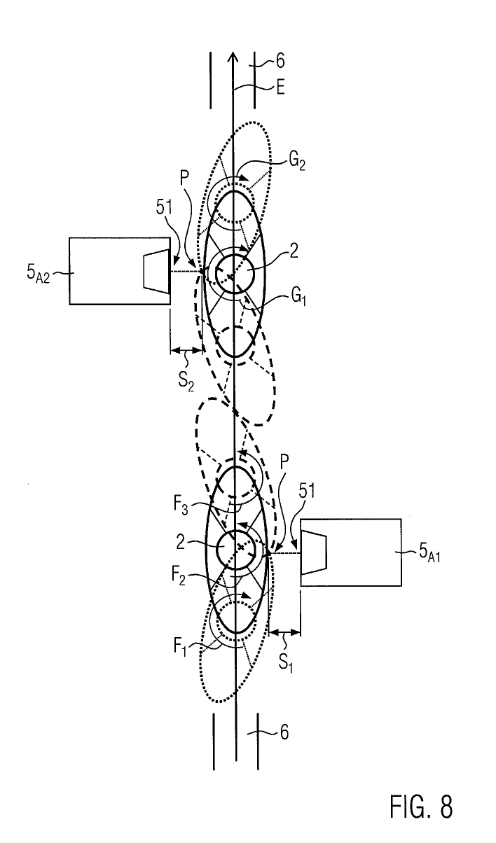

FIG. 8 shows a detail view of a further embodiment, in which two direct printing heads are arranged with an offset along the transport track for printing on a specially shaped container.

In FIG. 1, a survey of a container treatment machine 1 for printing on containers 2 with direct printing heads 5_{A1}-5_{E2} is shown in a top view. It can be seen that the containers 2 are transferred from the distributor carousel 10 by means of an infeed star wheel 11 to the transport device 3 configured as a carousel. There, they are received in the container accommodation units 4, which each comprise a rotary plate and a centering bell (here not shown in detail). Making use of the container accommodation units 4, the containers 2 are first pretreated at the primer station 8, whereupon they are moved to the individual printing positions between two direct printing heads 5_{A1}/5_{A2}, 5_{B1}/5_{B2}, 5_{C1}/5_{C2}, 5_{D1}/5_{D2}, 5_{E1}/5_{E2}, where each of them is printed on with the same printing ink. To this end, the direct printing heads 5_{A1}/5_{A2}, 5_{B1}/5_{B2}, 5_{C1}/5_{C2}, 5_{D1}/5_{D2}, 5_{E1}/5_{E2} are connected, in pairs, to a respective ink feeding unit, e.g. for the colors white, yellow, magenta, cyan and black. Subsequently, the containers 2 are cured by the curing unit 9 and returned to the distributor carousel 10 by means of the delivery star wheel 12. The distributor carousel 10 and the transport device 3 rotate in the directions R₂ and R₁, respectively, about their respective vertical axes. It is here imaginable, but not relevant to the present invention, that the distributor carousel 10 has arranged thereon a plurality of transport devices 3 with respective primer stations 8, direct printing heads 5 and curing units 9 as satellites.

It can also be seen that the direct printing heads 5_{A1}-5_{E2} are arranged stationarily on the transport track 6. For this purpose, the machine base has arranged thereon suitable holders for the direct printing heads 5_{A1}-5_{E2} (here not shown). In addition, the machine control unit 13 is shown, which controls the whole container treatment machine 1 including the components thereof.

The direct printing heads 5_{A1}/5_{A2}, 5_{B1}/5_{B2}, 5_{C1}/5_{C2}, 5_{D1}/5_{D2}, 5_{E1}/5_{E2} are arranged, in pairs, on different sides of the transport track 6, so that the containers 2 can simultaneously be printed on with the same ink from both sides. When, as shown in FIG. 1-6B, rotationally symmetric containers 2 are printed on, the containers 2 are brought to a standstill at printing positions between two direct printing heads 5_{A1}/5_{A2}, 5_{B1}/5_{B2}, 5_{C1}/5_{C2}, 5_{D1}/5_{D2} and 5_{E1}/5_{E2}, respectively, and rotated by means of the container accommodation units 4. In this way, the entire container surface can be printed on. However, specially shaped containers having a non-rotationally-symmetric surface are, alternatively or additionally, advanced along the transport track 6 while they are being printed on (FIG. 7A-8).

Although the embodiments following hereinafter refer to the two direct printing heads 5_{A1}/5_{A2}, the statements made apply, in a corresponding manner, also to the other pairs of direct printing heads 5_{B1}/5_{B2}, 5_{C1}/5_{C2}, 5_{D1}/5_{D2} and 5_{E1}/5_{E2}, respectively, with other printing inks. For the present invention, it is irrelevant how many pairs of direct printing heads are arranged in a container treatment machine.

FIG. 2A-2B show, in a side view (FIG. 2A) and a top view (FIG. 2B), a detail view of the two direct printing heads 5_{A1}/5_{A2} with the container 2 arranged therebetween during a printing process. It can be seen that the container 2 is located along the transport track 6 at the printing position between the two direct printing heads 5_{A1} and 5_{A2} and is there printed on simultaneously from both sides. To this end, the two direct printing heads 5_{A1} and 5_{A2} are arranged on the transport track 6 in opposed relationship with one another on the same height level with respect to the longitudinal axis A of the container, so that both print areas 21 and 22 can be printed on simultaneously.

The direct printing heads 5_{A1}, 5_{A2} are inkjet printing heads, in the case of which the printing nozzles 51 are arranged in a nozzle row at regular intervals. Likewise, it is imaginable that the direct printing heads each comprise a group of nozzles with a plurality of nozzle rows arranged in parallel.

For rotating the containers, the direct drives 7 are provided in the container accommodation units 4, said direct drives 7 being configured e.g. as servomotors. The containers 2 can thus be rotated about their longitudinal axis A during the printing process, so that the direct prints 2a and 2b can be applied circumferentially.

It can also be seen that the direct printing heads 5_{A1}, 5_{A2} and the direct drives 7 are controlled by the machine control unit such that the container 2, while being printed on, rotates in a direction D by 180° about its longitudinal axis A and, during this rotation, respective print areas 21, 22 of the container 2 are printed on simultaneously by each of the direct printing heads 5_{A1}, 5_{A2}. Thus, the two parts 2a and 2b of the direct print adjoin one another directly in the circumferential direction. It is, however, also imaginable that the container 2, while being printed on, is rotated by less than 180° or that the direct print parts 2a and 2b do not adjoin one another directly.

Due to the fact that the container 2 only has to be rotated by 180° while being printed on, a higher throughput of containers through the container treatment machine 1 is accomplished.

FIGS. 3A and 3B show, in a side view (FIG. 3A) and in a top view (FIG. 3B), a further embodiment for an alternative use of the direct printing heads 5_{A1} and 5_{A2}. The mode of arrangement of the direct printing heads 5_{A1} and 5_{A2} does not differ from that in FIGS. 2A and 2B. The present embodiment is, however, different insofar as a print area 23 of the container 2 is printed on redundantly by means of the two direct printing heads 5_{A1} and 5_{A2}.

The container 2 is first rotated in the container accommodation unit 4 by 180° about its longitudinal axis A in direction D by means of the direct drive 7 and has printed thereon a lower layer 2c of the direct print while it is being rotated. In the course of this process, each of the two direct printing heads 5_{A1} and 5_{A2} ejects half the amount of printing ink required for the respective print dot. Three ink droplets, by way of example.

Subsequently, the container 2 is rotated by another 180° in direction D so as to apply an upper ink layer 2d to the container 2. In the course of this process, each direct printing head 5_{A1}, 5_{A2} ejects the second half of the amount of printing ink onto the container 2. By way of example, three further ink droplets onto the above mentioned print dot. It follows that, on the whole, the container 2 is rotated in direction D by 360°.

This course of action has the advantage that each printing point is printed on redundantly by both direct printing heads 5_{A1} and 5_{A2} and that, even if a nozzle should fail in one of the two direct printing heads 5_{A1} and 5_{A2}, respectively, there will be no print line without color. This will improve the quality of the direct print 2c, 2d.

FIG. 4A-4B show a detail view of a further embodiment in a side view (FIG. 4A) and in a top view (FIG. 4B), the two direct printing heads 5_{A1}, 5_{A2} being here arranged with an offset T in the direction of the nozzle rows on the transport track 6 in order to increase the print resolution. The offset T amounts to half the distance U between two neighboring printing points of a nozzle group. Since the direct printing heads 5_{A1}, 5_{A2} each comprise a nozzle group with a nozzle row, the distance U corresponds to the distance between two neighboring printing nozzles 51 of a nozzle row. As for the rest, the arrangement in the embodiment of FIG. 4A-4B corresponds to the preceding embodiments according to FIG. 1-3B.

During printing, the container 2 is rotated in direction D by 380° by means of the direct drive 7 of the container accommodation unit 4, so that the two direct prints 2e, 2f are printed on in an interlaced manner in the print area 23. In other words, the image lines of the whole print area 23 are printed alternately by one of the two direct printing heads 5_{A1}, 5_{A2}. Hence, the print resolution and, consequently, the print quality of the direct print 2e, 2f is increased by the offset T.

FIG. 5A-5B show a detail view of a further embodiment in a side view (FIG. 5A) and in a top view (FIG. 5B), the direct printing heads 5_{A1} and 5_{A2} being here arranged with an offset V in the direction of the nozzle rows on the transport track 6. The offset V corresponds to the length of a nozzle row W added to the distance U between two neighboring printing points. As for the rest, the embodiment in FIG. 5A-5B corresponds to the preceding embodiments.

During printing, the container 2 is rotated about its longitudinal axis A in direction D by 360° by means of the container accommodation unit 4 and the direct drive 7. In the course of this process, it is printed on from both sides simultaneously by means of the two direct printing heads 5_{A1}, 5_{A2}, so that the two direct prints 2g and 2h are applied to the container 2 directly one on top of the other. However, it is also imaginable to provide a distance between the two direct prints 2g, 2h.

In this way, the entire print height can be doubled and, consequently, the print quality can be improved.

FIG. 6A-6B show, in a side view (FIG. 6A) and in a top view (FIG. 6B), a detail view of a further embodiment with an arrangement of the direct printing heads 5_{A1} and 5_{A2} alternative to that of the preceding embodiment. The embodiment in FIG. 6A-6B is different essentially insofar as the direct printing heads 5_{A1} and 5_{A2} are arranged on the same side of the transport track 6. To this end, the direct printing heads 5_{A1} and 5_{A2} exhibit relative to one another the offset V in the direction of the nozzle rows as well as an offset X along the transport track 6, so that the print lines of the direct prints 2g, 2h will adjoin one another directly. The direct printing heads 5_{A1}, 5_{A2} are here oriented such that the container 2 can be printed on simultaneously at a printing position.

A corresponding arrangement of the direct printing heads 5_{A1}, 5_{A2} on the same side of the transport track with the offset X is also imaginable for the embodiments in FIGS. 3A-3B and 4A-4B.

Due to the arrangement of the direct printing heads 5_{A1}, 5_{A2} on the same side of the transport track 6, particularly simple holders can be used.

FIG. 7A-7C show a detail view of a further embodiment, the container 2 being here configured as a specially shaped container. As can be seen in FIG. 7A, the container 2 is located between the two direct printing heads 5_{A1} and 5_{A2}, which are arranged in opposed relationship with one another on the transport track 6. In this way, the print areas 21, 22 can be provided with the direct prints 2i and 2k on both container halves simultaneously.

As can be seen in FIG. 7B in a top view, the specially shaped container 2 moves, while it is being printed on, along the direction E of the transport track 6. This is advantageous insofar as the two sides of the container 2 are configured as substantially flat surfaces. Hence, the distance between these flat surfaces and the direct printing heads 5_{A1}, 5_{A2} is approximately constant during printing.

Due to the fact that the specially shaped container 2 is printed on simultaneously by the two direct printing heads 5_{A1}, 5_{A2} with the same printing ink, the container throughput can be increased.

In FIG. 7C, a total of four of the direct printing heads 5_{A1}, 5_{A2}, 5_{A3}, 5_{A4} used for applying the same printing ink is provided on both sides of the transport track 6 for increasing the container throughput or for improving the print quality. In correspondence with the preceding embodiment, the direct printing heads on one side 5_{A1}, 5_{A3} or 5_{A2}, 5_{A4} may print onto only half the print areas 21, 22 of the container 2 in order to increase the container throughput, they may be used redundantly in order to improve the print quality and/or may be arranged on the transport track 6 with a suitable offset in the direction of the printing nozzles in order to increase the print resolution and the print height, respectively.

FIG. 8 shows, in a top view, a detail view of a further embodiment, in the case of which two direct printing heads 5_{A1}, 5_{A2} used for printing on the container 2 are arranged along the transport track 6 in an offset mode of arrangement. It can be seen that the container 2 is configured as a specially shaped container with a cross-section that deviates from rotational symmetry. An elliptical shape is here shown by way of example, but also any other surface shape that is suitable for being printed on is imaginable.

During printing, the container 2 is first moved past the first direct printing head 5_{A1} and the leading edge thereof is rotated towards the direct printing head 5_{A1} according to the direction of rotation F₁. As the printing process continues, the container 2 is rotated contrarily in the directions F₂-F₃ while travelling past the direct printing head 5_{A1}. The respective printing points P on the container are thus located at a substantially constant printing distance S₁ from the direct printing head 5_{A1}, whereby the print image is improved.

Subsequently, the container 2 is advanced along the transport track 6 such that it moves along the direct printing head 5_{A2} and is rotated with a further pivotal movement G₁ and G₂ such that the printing distance S₂ remains again substantially constant. Hence, also the second side of the container is printed on with high print quality.

Furthermore, it is imaginable that the container 2 is moved such that a constant printing speed is achieved. If, for example, the direct printing heads 5_{A1} and 5_{A2} are configured for a printing speed of 24 m/min, the superposition of the feed rate and of the surface speed of the container 2 resulting from the rotation should amount to these 24 m/min as precisely as possible, so as to prevent image errors.

It is imaginable that the transport track 6 is provided with suitably configured container accommodation units, so as to move the container 2 past the direct printing heads 5_{A1} and 5_{A2} at a constant printing distance and with a constant printing speed.

The container treatment machines 1 for printing on containers 2 in the above embodiments according to FIG. 1-8 are used as follows:

The container flow is transported along the transport track 6 by a transport device 3 configured as a carousel, and the containers are printed on with the direct prints 2a-2k by means of the direct printing heads 5_{A1}/5_{A2}, 5_{B1}/5_{B2}, 5_{C1}/5_{C2}, 5_{D1}/5_{D2}, 5_{E1}/5_{E2} arranged stationarily on the transport track 6. In the course of this process, the same printing ink is applied to a container 2 by two respective direct printing heads 5_{A1}/5_{A2} operating in pairs.

For example, the color white is applied by the direct printing heads 5_{A1}/5_{A2}, then the color yellow is applied by the two direct printing heads 5_{B1}/5_{B2}, whereupon the color magenta is applied by the two direct printing heads 5_{C1}/5_{C2}, then the color cyan is applied by the two direct printing heads 5_{D1}/5_{D2} and, finally, the color black is applied by the two direct printing heads 5_{E1}/5_{E2}. It is imaginable that two additional direct printing heads are arranged on the transport track 6 for applying special colors.

It goes without saying that the features mentioned in the above described embodiments are not limited to these special combinations and can also be provided in arbitrary other combinations.

1. A container treatment machine for printing on containers, comprising:
a transport device for transporting a container flow along a transport track; and further comprising
a plurality of direct printing heads stationarily arranged on the transport track and used for applying a direct print to the containers, wherein at least two of the plurality of direct printing heads are configured for applying the same printing ink to a container of the containers, wherein the container accommodation units are configured such that they are rotatable by means of direct drives and wherein a machine control unit is configured for controlling the direct drives as well as the direct printing heads, wherein the machine control unit is configured for rotating the container accommodation units such that a print area of the container is adapted to be printed on by both direct printing heads, wherein all the printing points of the print area are adapted to be printed on by both direct printing heads for redundancy.

2. The container treatment machine according to claim 1, wherein the at least two direct printing heads each comprise in a nozzle group at least one row with regularly spaced printing nozzles, and wherein the at least two direct printing heads are arranged with an offset in the direction of the nozzle rows on the transport track.

3. The container treatment machine according to claim 2, wherein, for increasing a print resolution, the offset corresponds to the distance between two neighboring printing points of a nozzle group multiplied by the factor 0.5+k, k being a positive or a negative integer or zero.

4. The container treatment machine according to claim 2, wherein, for increasing a print height, the offset in the direction of the nozzle rows corresponds to at least a length of the nozzle row.

5. The container treatment machine according to claim 1, wherein the at least two direct printing heads are arranged on the transport track in opposed relationship with one another, so that two print areas of a container are printed on simultaneously.

6. The container treatment machine according claim 1, wherein the at least two direct printing heads are arranged on different sides of the transport track and/or in a direction of the transport track in succession.

7. The container treatment machine according to claim 1, wherein, for increasing a container throughput and/or a print quality, four direct printing heads of the plurality of direct printing heads are configured for applying the same printing ink to a container.

8. The container treatment machine according to claim 1, wherein the machine control is configured for rotating the container accommodation unit by up to 180° while two print areas are printed on simultaneously.

9. The container treatment machine according to claim 8, wherein the machine control unit is configured for rotating the container accommodation unit when a non-rotationally-symmetric surface area of the container is being printed on, such that a printing distance to the direct printing head carrying out the printing operation will remain substantially.

10. A method for printing on containers, comprising:
applying a direct print to the containers, wherein the containers are a part of a container flow that is transported along a transport track by means of a transport device, and where the containers have the direct print applied thereto by means of a plurality of direct printing heads arranged stationarily on the transport track, wherein the same printing ink is applied to a container of the containers at least by means of at least two of plurality of direct printing heads, wherein the same print area on the container is printed on by the at least two direct printing heads with a respective part of a printing ink quantity per printing point.

11. The method for printing containers according to claim 10, wherein the at least two direct printing heads are arranged in opposed relationship with one another on the transport track and two print areas of the container are printed on simultaneously.

12. The method for printing on containers according to claim 10, wherein, for printing on a non-rotationally-symmetric area of the container, the container is rotated such that a printing distance to the at least two direct printing head carrying out the printing operation will remain substantially constant.

13. The method for printing on containers according to claim 12, wherein the at least two direct printing heads are arranged in opposed relationship with one another on the transport track and two print areas of the container are printed on simultaneously.

14. The method for printing on containers according to claim 12, wherein the same print area on the container is printed on by the at least two direct printing heads in an interlaced manner or with a respective part of the printing ink quantity per printing point.

15. The method for printing on containers according to claim 12, wherein, for printing on a non-rotationally-symmetric surface area of the container, the container is rotated such that a printing distance to the at least two direct printing heads carrying out the printing operation will remain substantially constant.

16. The container treatment machine according to claim 1, wherein the transport device is configured as a carousel.

17. The container treatment machine according to claim 3, wherein k is half the distance between the two neighboring printing points of a nozzle group.

18. The method according to claim 10, wherein the transport device is configured as a carousel.

19. The method according to claim 11, wherein the two print areas of the container are printed on simultaneously while the container is rotated by up to 180°.

20. The method according to claim 13, wherein the two print areas of the container are printed on simultaneously while the container is rotated by up to 180°.
